(19) United States
(12) Patent Application Publication
(10) Pub. No.: US 2017/0021914 A1
(43) Pub. Date: Jan. 26, 2017

(54) FIBER OPTIC SENSING AND CONTROL SYSTEM

(71) Applicant: Moog Inc., East Aurora, NY (US)

(72) Inventors: George L. Small, Williamsville, NY (US); Glynn Lloyd, Sutton Coldfield (GB); Seth E. Gitnes, Snohomish, WA (US)

(21) Appl. No.: 15/102,481

(22) PCT Filed: Dec. 8, 2014
(86) PCT No.: PCT/US2014/069083

§ 371 Date: Jun. 7, 2016

Related U.S. Application Data
(60) Provisional application No. 61/914,905, filed on Dec. 11, 2013.

(51) Int. Cl. B64C 13/50; B64C 13/16; B64D 45/00; G01D 5/353

(52) U.S. Cl. CPC B64C 13/503; G01D 5/353; B64C 13/16; B64D 45/0005; B64D 2045/001; B64D 2045/0085

(57) ABSTRACT

An improved flight control system comprising a flight control surface of an aircraft or spacecraft, a first optical fiber having a fiber optic sensor configured to sense a first parameter associated with the flight control surface at a first position and a second fiber optic sensor configured to sense a second parameter associated with the flight control surface at a second location, an interrogator connected to the first optical fiber and configured to convert the sensed parameters from both the first fiber optic sensor and the second fiber optic sensor into an electrical signal, and the interrogator communicating with a flight control computer.

### TECHNICAL FIELD

The present invention relates generally to aeronautical flight control systems, and more particularly to a fiber optic sensing aeronautical flight control system for various manned and unmanned air and space vehicle applications.

### BACKGROUND ART

Current state of the art commercial or military aircraft integrated fly-by-wire flight control systems (IFCS) feature multiple and often redundant instances of force sensing, pressure sensing, position sensing and skew detection sensing to provide higher level flight control functions. These sensors are used for primary and high lift control surface load monitoring, load equalization, load limiting and fault detection functions. Current state of the art IFCS typically implement this sensing functionality with wire wound linear variable differential transformers (LVDTs), rotary variable differential transformers (RVDTs), resolvers, linear and rotary potentiometers, and strain gauge based load and pressure sensors. Each of these sensors has with it associated wiring, power conditioning and signal conditioning. These sensors may be powered and amplified by central control electronics located within the aircraft pressure vessel (typically fuselage fore and aft equipment bays) or by remote mounted control electronics and data concentrators located outside the aircraft pressure vessel (typically in the aircraft wing and tail surfaces, or fuselage extremities).

### BRIEF SUMMARY OF THE INVENTION

With parenthetical reference to the corresponding parts, portions or surfaces of the disclosed embodiment, merely for the purposes of illustration and not by way of limitation, an improved flight control system (200) is provided comprising a flight control surface (203, 205a, 205b, 207a, 207b, 209, 211a, 211b, 212a, 212b, 213a, 213b, 225a, 225b, 226a, 226b, 227a, 227b) of an aircraft or spacecraft (204), a first optical fiber (100a), the first optical fiber having a fiber optic sensor (102a) configured and arranged to sense a first parameter associated with the flight control surface at a first position and a second fiber optic sensor (102a) configured and arranged to sense a second parameter associated with the flight control surface at a second location, an interrogator (101a) connected to the first optical fiber and configured and arranged to convert the sensed parameters from both the first fiber optic sensor and the second fiber optic sensor into an electrical signal, and the interrogator communicating with a flight control computer (105).

The first parameter and the second parameter may be the same parameter. The first parameter and the second parameter may be different parameters. The first parameter and the second parameter may be selected from a group consisting of position, load, skew, pressure and strain. The first fiber optic sensor may comprise a fiber Bragg grating. The first location and the second location may be selected from a group consisting of a wing (217a, 217b), a horizontal stabilizer (221a, 221b), and a vertical stabilizer (219) of an aircraft. The first location and the second location may be selected from a group consisting of an aileron (205a, 205b), an elevator (207a, 207b), a rudder (209), a spoiler (211a, 211b, 212a, 212b), a flap 225a, 225b, 226a, 226b), a flaperon (213a, 213b) and a slat (227a, 227b) of an aircraft. The control system may further comprise a third fiber optic sensor (102a) configured and arranged to sense a third parameter associated with the flight control surface at a third position and a fourth fiber optic sensor (102a) configured and arranged to sense a fourth parameter associated with the flight control surface at a fourth position.

In another aspect, an improved flight control system is provided comprising a flight control surface (203) of an aircraft or spacecraft (204), an actuator (201) configured and arranged to apply a force to the flight control surface, a first optical fiber (100a), the first optical fiber having a fiber optic sensor (102a) configured and arranged to sense a first parameter associated with the flight control surface, an interrogator (101a) connected to the first optical fiber and configured and arranged to convert the sensed parameters from the first fiber optic sensor into an electrical signal, and the interrogator communicating with the actuator.

The interrogator may be configured and arranged to send a command sign to the actuator multiplexed over the first optical fiber. The first optical fiber may have a second fiber optic sensor (102a) configured and arranged to sense a second parameter associated with the flight control surface at a second location and the interrogator may be configured and arranged to convert the sensed parameters from the second fiber optic sensor into an electrical signal.

### BRIEF DESCRIPTION OF THE DRAWINGS

FIG. 1 is a perspective view of a first embodiment aircraft.

FIG. 2 is a schematic view of a first embodiment fiber optic sensing aircraft flight control system.

FIG. 3 is a block process diagram of the flight control system shown in FIG. 2.

FIG. 4 is a schematic view of a prior art actuator unit, showing actuator 201 configured to move flight control surface 203 at the direction of on-actuator electronic unit 202.

### DESCRIPTION OF EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

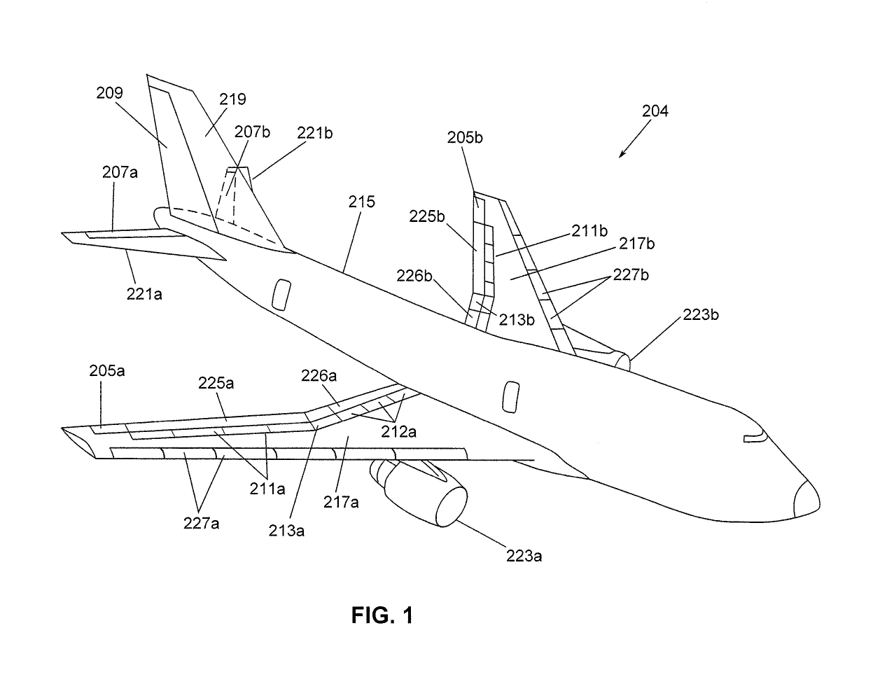

Referring to FIG. 1, conventional commercial aircraft generally include fuselage 215, wings 217a and 217b, vertical stabilizer 219, horizontal stabilizers 221a and 221b, and engines 223a and 2236. A plurality of flight control surfaces controllably direct the movement of aircraft 204. These flight control surfaces typically include both primary flight control surfaces and secondary flight control surfaces or high lift control surfaces. Primary flight control surfaces are generally those used to control aircraft movement in the pitch, yaw, and roll axes, and secondary flight control surfaces are generally those used to influence the lift or drag of the aircraft.

The primary flight control surfaces in this embodiment include a pair of ailerons 205a and 205b, a pair of elevators 207a and 207b, and rudder 209. Ailerons 205a and 205b are located on the outer trailing edges of wings 217a and 217b of aircraft 204 and control the roll of the aircraft. Elevators 219 are located on horizontal stabilizers 221a and 221b of aircraft 204 and control the pitch of the aircraft. Rudder 209 is located on vertical stabilizer 219 and controls the yaw of the aircraft.

The secondary flight control surfaces on the aircraft include multiple outboard spoilers 21 la and 211b, multiple inboard spoilers 212a and 212b, outboard flaps 225a and 225b, inbound flaps 226a and 226b, flaperons 213a and 213b, and multiple slats 227a and 227b. Spoilers, 211a, 211b 212a and 212b are located on wings 217a and 217b and assist in the control of vertical flight path, act as air brakes to control the forward speed of the aircraft, and act as ground spoilers to reduce wing lift to help maintain contact between the landing gear and the runway when braking. Flaps 225a, 225b, 226a and 226b and slats 227a and 227b are located on the wings of the aircraft to change the lift and drag forces effecting the aircraft, with flaps 225a, 225b, 226a and 2266 at the trailing edge of wings 217a and 2117b, respectively, and slats 227a and 227b at the leading edge of wings 217a and 217b, respectively. When flaps 225a, 225b, 226a and 226b and slats 227a and 227b are extended, the shape of the wing changes to provide more lift. With an increased lift, the aircraft can travel at lower speeds.

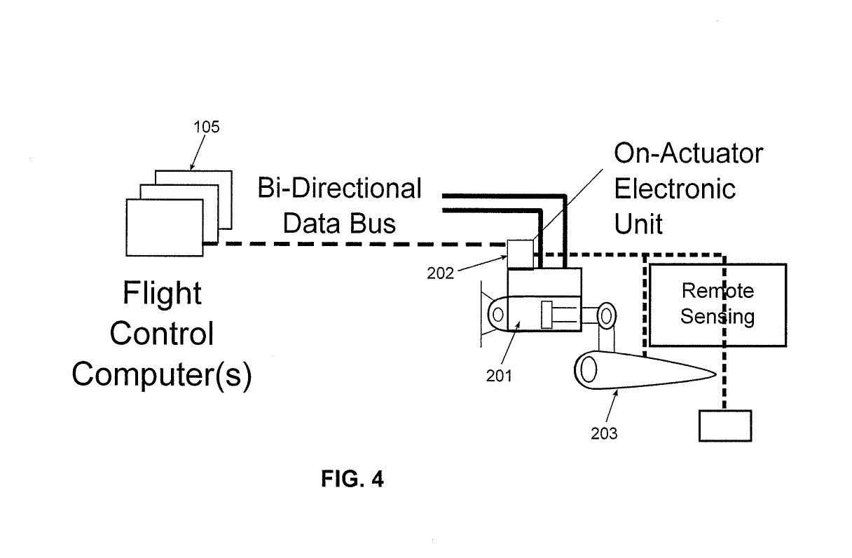

The positions of the aircraft flight control surfaces are typically moved between retracted and extended positions using a flight control surface actuation system. The flight control surface actuation system, in response to position commands that originate from either the flight crew or an aircraft autopilot, moves the aircraft flight control surfaces to the commanded positions. In most instances, this movement is effected via primary and secondary surface control systems having primary and secondary surface control actuators that are coupled to the flight control surfaces. The primary flight control surface actuators, shown schematically at 201, generally include elevator actuators, rudder actuators, and aileron actuators. The secondary control surface actuators will generally include flap actuators, slat actuators and spoiler actuators. The number of flight control surface actuators per flight control surface may be varied depending, for example, on the size of the control surface. As shown in FIG. 4, actuator 201 moves flight control surface 203 at the direction of on-actuator electronic unit 202.

The primary flight control actuation system and the secondary flight control actuation systems include associated control electronics. In conventional fly-by-wire aircraft, electronic sensors are attached to the pilot's controls. These sensors transmit electronic data to at least one flight control computer (“FCC”), shown in this embodiment at 105. Actuator control electronics receive the electronic signals from flight control computers 105 and move the actuators 201 based on the received signals such that movement of the actuator moves the subject control surface.

The flight control surface actuation system also includes a plurality of control surface position sensors. The control surface position sensors sense the positions of the flight control surfaces and supply control surface feedback signals representative thereof to the actuators and flight control computers 105.

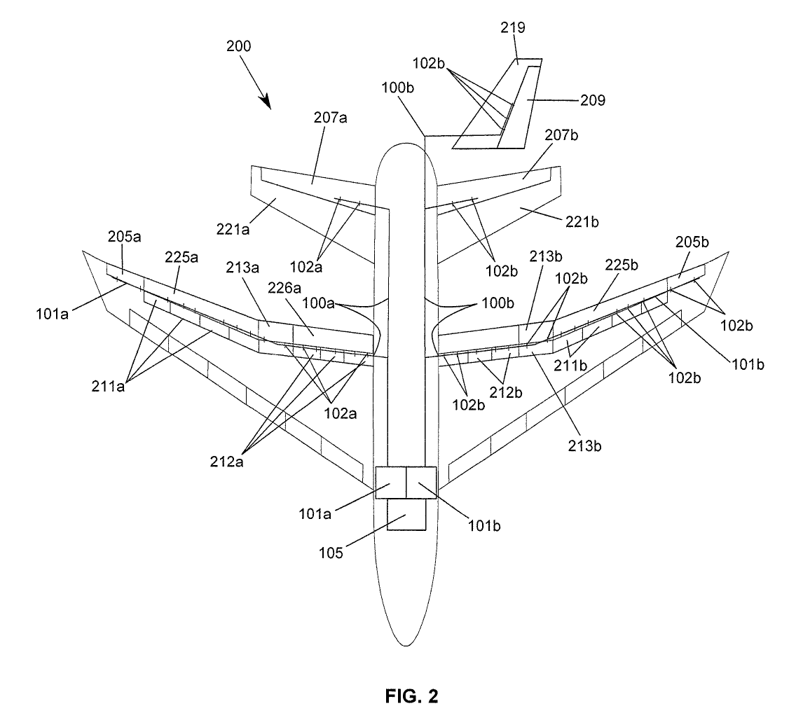

With reference to FIG. 2, an improved fiber optic control system is provided, an embodiment of which is indicated at 200. As shown, in system 200 certain of the primary and secondary flight control actuation systems on wings 217a comprise sensing optical fiber 100a feeding a single interrogator unit 101a. Similarly, certain of the primary and secondary flight control actuation systems on wings 217b comprise sensing optical fiber 100b feeding a second single interrogator unit 101b. As shown, each of fibers 100a and 100b includes multiple fiber optic-sensing points, severally indicated at 102a and 102b, respectively, used to measure parameters of the subject flight control surfaces. Each of the cross-marks on fiber lines 100a and 100b represents a fiber optic sensing point. As shown, the fiber optic sensing points on vertical stabilizer 219 are part of fiber optic line 100b. Alternatively, a separate fiber optic line may be used for rudder 209.

The fiber optic sensing points may be integrated into or coupled to the subject flight control surface, to one or more control surface actuators, to one or more associated structural links or struts, or to any combination of the these.

In the embodiment of FIG. 2, at least one fiber optic sensing point 102a and 102b is coupled to each primary flight control surface and secondary flight control surface, and in some cases multiple fiber optic sensing points are used for a primary or secondary flight control surface. It will be appreciated, however, that this is merely exemplary of a particular embodiment and that more or less than this number of fiber optic sensing points could be used.

In this embodiment, each fiber optic sensing point 102 comprises a “fiber Bragg grating” (“FBG”) sensor or component thereof. FBGs sensors may be used to measuring different operating parameters of the aircraft. An FBG is generally formed in a single mode optical fiber by creating a periodic refractive index perturbation in the fiber core. This diffraction grating in the fiber core reflects optical frequencies within a narrow bandwidth around the Bragg wavelength of the optical grating, and the Bragg wavelength of the diffraction grating can be varied by changing the grating pitch. If an external influence alters the grating pitch then the reflection spectrum of the grating can be monitored to determine the magnitude of the external influence. For example, if the grating is subject to varying strain or temperature, the pitch of the grating is altered and by coupling the grating to an appropriate transducer, the grating can be used to monitor a wide variety of parameters, including without limitation strain, load, deformation, temperature, vibration, pressure, acceleration, inclination, displacement, torque, skew, bending and chemical concentration.

In this embodiment, sensing points 102a and 102b are configured to measure strain or load. International Publication WO 2004/056017, which is incorporated herein in its entirety by reference, discloses a method of interrogating multiple FBG strain sensors along a single fiber. FBGs are positioned in the optical fiber at spaced locations along the optical fiber. When the optical fiber is put under strain, the relative spacing of the planes of each Bragg grating changes and thus the resonant optical wavelength of the grating changes. By determining the resonant wavelength of each grating, a strain measurement can be derived for the location of each grating along the fiber. To remove the effect of temperature on a strain sensor, it is known to use a sensor isolated from the strain of the structure being measured to detect the effect of temperature alone and to compensate the strain measurement on the basis of the reading from the unstrained sensor.

FBGs 102a are preferably located on a single optical fiber 100a connected to interrogator 101a. FBGs 102b are preferably located on a single optical fiber 100b connected to interrogator 101 b. Hundreds of strain sensors could be located down the length of the fiber.

Interrogators 102a and 102b are configured to interrogate optical fibers 100a and 100b, respectively, and the plurality of FBGs 102a and 102b, respectively. U.S. Pat. No. 8,339,591, entitled “Apparatus for Interrogating Fibre Bragg Gratings,” which is incorporated herein in its entirety by reference, discloses a representative interrogation system. In this embodiment, the interrogator uses time division multiplexing (TDM). The interrogator comprises a delay arrangement in an optical path for light supplied to and/or reflected from the FBGs. The delay arrangement is configured to apply a different time delay to light in each of the discrete wavelength bands, whereby the light reflected from each of the FBGs is received at an interrogator port of the apparatus in a different discrete time interval. The light reflected from each FBG is identified by the time of arrival of a reflected light pulse at a detector, such that the reflected signals from multiple gratings in a single fiber are multiplexed in the time domain. Thus, in this TDM based system, generally all of the gratings within the array are within the same wavelength window, with the gratings being illuminated by a pulsed optical source. In the simplest TDM based system a single short broad bandwidth pulse launched into one end of the fiber will reach a particular grating in the array at a particular moment in time. The grating will reflect part of the optical pulse, and the reflected signal will propagate back down the fiber towards the optical source and a wavelength measurement system. Pulses reflected from other gratings within the array will arrive at the measurement system at different times, since they will have travelled different distances.

Alternatively, reflected light from the FBGs may also be processed using waveform or wavelength division multiplexing (WDM) or optical frequency domain reflectometry (OFDR) techniques. Sometimes, a combination of both techniques may be used to process the optical data from the reflected light. Grating could also be provided continuously along the length of the optical fiber and either OFDR technique or WDM technique or combination of OFDR and WDM techniques used to process the optical data. The light reflected from each fiber Bragg grating is identified by the time of arrival of a reflected light pulse at a detector, such that the reflected signals from multiple gratings in a single fiber are multiplexed in the time domain.

Using WDM, each grating in a single optical fiber has a resonant wavelength in a different discrete wavelength band. In this way, the reflected light from each grating can be identified by the resonant wavelength of light reflected, which means there is no limitation on the location of the gratings along the fiber. Thus, using WDM to accommodate the signals from each strain sensor 102a along the optical fiber 100, each sensor 102a in the same array is identified by its wavelength λ and must therefore have a different wavelength at all times from other sensors 102a in the same array.

An alternative TDM technique utilizes short optical pulses of a single known wavelength. Only gratings within the array whose resonant wavelength matches that of the pulse will reflect the pulse. By changing the wavelength of the optical signal between pulses the full spectrum of the grating array may be scanned and wavelength of each of the gratings determined.

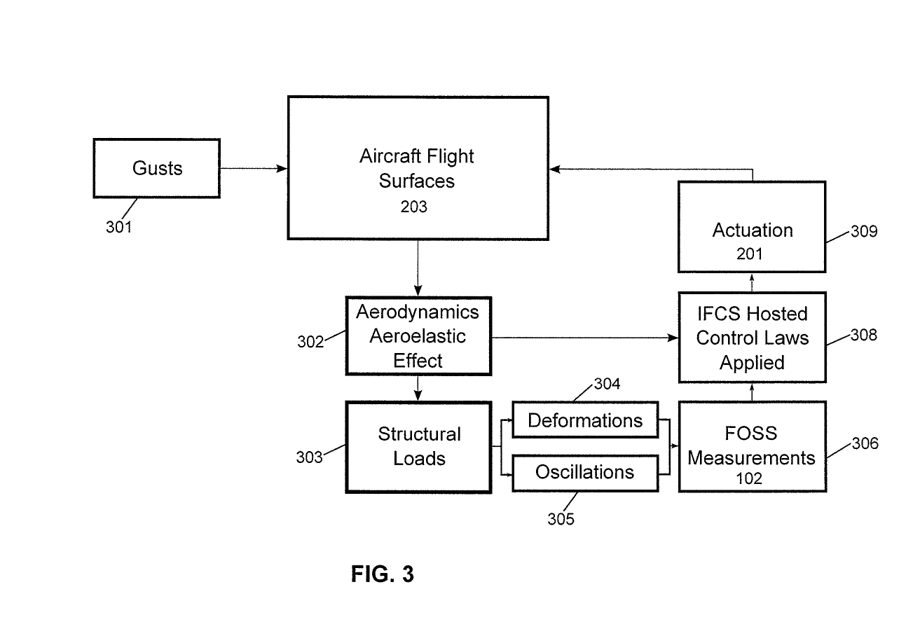

As shown in FIG. 3, as gusts of wind or other forces 301′ contact the flight surfaces 203 of aircraft 204, certain aeroelastic effects 302 and structural loads 303 are applied. Such structural loads cause deformation 304 and oscillations 305 that are measured by fiber optic sensors 102 in fiber optic line 100, and such measurements 306 are analyzed 308 by flight control computer 105. The results can then be fed back to the subject actuator 201 to actuate 309 the subject actuator 201 and control the subject flight control surface 203. In one embodiment, such data command signals to the subject actuators are multiplexed and transmitted over the fiber optic lines 100.

With system 200, a single electro-optical interrogator can multiplex hundreds of sensors onto one optical fiber. The sensing location can be hundreds of meters from the electo-optical interrogator with little to no signal loss. In addition, fiber optic sensors may be embedment into the structure of the aircraft, particularly composite structures, and used to monitor and control such structures for diagnostic and control purposes.

System 200 can be used in multiple alternate forms. For example, system 200 could be tightly integrated with ‘active’ aerostructures and offered as add on components to existing non-integrated aerostructures. Second, system 200 could be modified so that the primary and high lift system functionalities are not integrated but are instead provided on separate optical lines with separate interrogators. In this regard the number of optical lines and interrogators could be varied as desired. Third, system 200 can be provided with data command signaling multiplexed over the same optical fiber used for sensing. Thus, data command signaling to the actuators 201 is multiplexed over fiber 100, for example. Fourth, a FBG based integrated structural health monitoring (SHM) sensing system capable of load monitoring as well as detecting, locating and quantifying cracks and de-laminations in composite structures such as smart composite wings with embedded FBG sensors may be added. Finally, any combination of the forgoing could be employed.

System 200 integrates a full range of functions into a single fiber and interrogator system for use on aircraft, spacecraft, missiles and other aeronautical devices, with data multiplexed over the same fiber used as the sense means. And system 200 can integrate structural health monitoring into the same fiber used as the sense means for shape prediction, pressure and load sense.

Fiber optic sensing system 200 has a number of benefits. The system provides multi-function sensing tightly integrated into ‘active’ aerostructures (i.e. moving leading and trailing edges, control surfaces, load sensing links, etc.) with associated sensing and control. The system allows for the integration of primary and high-lift systems with aerostructures to provide higher functionality with reduced complexity. Thus, the system provides existing functionality (load sensing, skew detection, position sensing, pressure sensing, other) at reduced cost, reduced parts count and improved reliability by replacing present systems which employ multiple discrete sensors and signal conditioners with one or more sense fibers feeding a single (or multiple for redundancy) interrogator unit. Given that each individual sense fiber may contain a hundred or more discrete sense points, the disclosed system will support a substantial increase in the practical number of sense points (load sensing, skew detection, position sensing, pressure sensing, other) with minimal incremental impact on system cost, weight or reliability as compared to present implementations. This will meet demands for increased functionality while simultaneously reducing cost, weigh and increasing system reliability.

Primary and high lift flight control systems in the prior art can require, without limitation, at least three extensive functional elements. First, the flight control system can typically include as many as fifteen primary control surface actuators; three for the rudder, four for the elevator, four for the flaperon and four for the aileron. Each of these actuators has an integrated differential pressure transducer based force measurement sub-system. This force measurement sub-system is used to measure actuator output force, which in turn is used for surface level force equalization (load sharing), electronic force limiting, and periodic check of the passive damping function. Each differential pressure transducer based force measurement system consists of a spring centered spool and bushing with spool position LVDT, along with local mounted LVDT excitation and demodulation circuitry. Second, prior art systems can typically include as many as fourteen spoiler panel mounted spoiler position sensors, each consisting of one wire wound resolver, a low backlash gearbox, a bearing support, and linkage assembly connecting the sensor assembly to the spoiler panel. The spoiler position sensor is used to increase the positional accuracy of the spoiler panel at the faired and “drooped” positions. Increased positional accuracy is needed to prevent excessive spoiler induced flap loads should the spoiler interfere with the flap in drooped (flaps deployed) positions. Third, prior art systems could typically include as many as eight dual channel flap panel skew sensor assemblies, with two dual channel sensor assemblies on each of the four flap panels. Each dual channel skew sensor assemblies can consist of a dual channel RVDT assembly, a bearing support and linkage assembly connecting the sensor assembly to the flap panel. With system 200, these three functional elements can all be replaced by one (or more as dictated by system safety and redundancy considerations) fiber optic sensing interrogator and a pair of fiber optic sense fibers (one on each wing). This brings a substantial reduction in cost, weight, envelope and power consumption, with improved system reliability due to reduced part count.

Besides the use in the flight control systems described above, system 200 can be modified for use in (i) landing gear load sensing for weight detection and center of gravity determination, (ii) wing, tail and fuselage strain sense, shape sense for modal suppression, gust load alleviation, and maneuver load alleviation, and (iii) differential pressure across flight and control surfaces for load detection, flow separation detection and gust load alleviation. Possible sensing functions are not limited to just flight control systems. Sensing of adjacent avionic systems may also be performed. For example, sensing functions may include, without limitation, fluid or fuel level monitoring, temperature monitoring, and structural deformations and modal shapes.

Therefore, while an embodiment of a fiber optic aircraft control system has been shown and described, and several modifications and alternatives discussed, persons skilled in this art will readily appreciate that various additional changes and modifications may be made without departing from the scope of the invention, as defined and differentiated by the claims.

What is claimed is:

1. An aeronautical control system comprising:
a flight control surface of an aircraft or spacecraft;
a first optical fiber;
said first optical fiber having a fiber optic sensor configured and arranged to sense a first parameter associated with said flight control surface at a first position and a second fiber optic sensor configured and arranged to sense a second parameter associated with said flight control surface at a second location;
an interrogator connected to said first optical fiber and configured and arranged to convert said sensed parameters from both said first fiber optic sensor and said second fiber optic sensor into an electrical signal; and
said interrogator communicating with a flight control computer.

2. The control system set forth in claim 1, wherein said first parameter and said second parameter are the same parameter.

3. The control system set forth in claim 1, wherein said first parameter and said second parameter are different parameters.

4. The control system set forth in claim 1, wherein said first parameter and said second parameter are selected from a group consisting of position, load, skew, pressure, fluid level, temperature and strain.

5. The control system set forth in claim 1, wherein said first fiber optic sensor comprises a fiber Bragg grating.

6. The control system set forth in claim 1, wherein said first location and said second location are selected from a group consisting of a wing, a horizontal stabilizer, a vertical stabilizer, and a body or fuselage of an aircraft or spacecraft.

7. The control system set forth in claim 1, wherein said first location and said second location are selected from a group consisting of a aileron, an elevator, a rudder, a spoilers, a flap, a flaperon and a slat of an aircraft.

8. The control system set forth in claim 1, and further comprising a third fiber optic sensor configured and arranged to sense a third parameter associated with said flight control surface at a third position and a fourth fiber optic sensor configured and arranged to sense a fourth parameter associated with said flight control surface at a fourth position.

9. An aeronautical control system comprising:
a flight control surface of an aircraft or spacecraft;
an actuator configured and arranged to apply a force to said flight control surface;
a first optical fiber;
said first optical fiber having a fiber optic sensor configured and arranged to sense a first parameter associated with said flight control surface;
an interrogator connected to said first optical fiber and configured and arranged to convert said sensed parameters from said first fiber optic sensor into an electrical signal; and
said interrogator communicating with said actuator.

10. The control system set forth in claim 9, wherein said interrogator is configured and arranged to send a command sign to said actuator multiplexed over said first optical fiber.

11. The control system set forth in claim 9, wherein said first optical fiber has a second fiber optic sensor configured and arranged to sense a second parameter associated with said flight control surface at a second location and said interrogator is configured and arranged to convert said sensed parameters from said second fiber optic sensor into an electrical signal.
